(19) United States
(12) Patent Application Publication
(10) Pub. No.: US 2014/0019478 A1
(43) Pub. Date: Jan. 16, 2014

(54) Correlated Tracing of Requests through TDS

(71) Applicants: Rong Wu, Redmond, WA (US); Cheryan Jacob, Redmond, WA (US); Jerome R. Halmans, Monroe, WA (US); Xinwei Hong, Sammamish, WA (US); Young Gah Kim, Bothell, WA (US)

(72) Inventors: Rong Wu, Redmond, WA (US); Cheryan Jacob, Redmond, WA (US); Jerome R. Halmans, Monroe, WA (US); Xinwei Hong, Sammamish, WA (US); Young Gah Kim, Bothell, WA (US)

(73) Assignee: MICROSOFT CORPORATION, Redmond, WA (US)

(21) Appl. No.: 13/545,253

(22) Filed: Jul. 10, 2012

(51) Int. Cl. G06F 17/30

(52) U.S. Cl. 707/770; 707/E17.014

(57) ABSTRACT

A trace header with an activity identifier is sent between a client and a database server as part of a request message stream. The activity identifier gets logged by client-side connection-related traces, by server-side traces, and by database engine traces. The activity identifier can be used to exactly correlate a thread on the client to threads on the server. Additionally, specific threads within a database engine may be correlated using the activity identifier to track the threads that processed a particular request. This enhances troubleshooting of the database system, particularly when there are many concurrent users and threads.

### BACKGROUND

The Tabular Data Stream (TDS) protocol is an application-level protocol used for the transfer of requests and responses between clients and database server systems, such as SQL Server®. In such systems, the client will typically establish a long-lived connection with the server. Once the connection is established using a transport-level protocol, TDS messages are used to communicate between the client and the server. The TDS session is directly tied to the transport-level session, meaning that a TDS session is established when the transport-level connection is established and the server receives a request to establish a TDS connection. It persists until the transport-level connection is terminated, such as when a TCP socket is closed. TDS does not make any assumption about the transport protocol used, but assumes that the transport protocol supports reliable, in-order delivery of the data.

TDS includes facilities for authentication and identification, channel encryption negotiation, issuing of SQL batches, stored procedure calls, returning data, and transaction manager requests. TDS packets are encapsulated in the packets built for the protocol stack used by the Net-Libraries. For example, if the system uses the TCP/IP Sockets Net-Library, then the TDS packets are encapsulated in the TCP/IP packets of the underlying protocol.

In current database systems, a physical connection generated on a client driver cannot be correlated to a connection on the database server. Similarly, a thread on a client machine cannot be correlated to a thread on a database server. Therefore, users cannot match what happened at the client machine to what was processed on the server. In one solution, developers may attempt to gather this information using network monitor or “netmon” tracing. Netmon tracing can be used to make a best case guess of which packet sent by TDS from the client correlated to what happened on the server. However, this solution does not work when the packets pass through a proxy server or used named pipes to connect. In another solution, for SQL Azure™ and SQL Server® post connection analysis, developers may query for connection identification information from system management views and store this value on the client driver to correlate the database's physical connection with the client connection that was opened. However, this solution only works post-login or when a connection open does not abruptly fail.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments provide correlated tracing requests sent by client drivers to a database server. This tracing is accomplished using an optional trace header that is added to the TDS protocol to enable correlated tracing of requests.

In one embodiment, an Activity Identifier (Activity ID) comprising a sixteen-byte GUID plus a four-byte sequence number is logged at each layer of the stack to enable correlation of requests. For example, the Activity ID may be logged using pre-login BID (Built-In Diagnostics) trace points on the client drivers, TDS protocol implementations, and server-side.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a high level block diagram of a client-server database system according to one embodiment.

FIG. 2 illustrates an example stack for client-server database system.

FIG. 3 illustrates a stream of packets that form a request.

FIG. 4 illustrates how request interacts with various threads within a SQL engine.

FIG. 5 is a flowchart illustrating a method or process for tracing requests in a database system.

FIG. 6 illustrates an example of a suitable computing and networking environment on which the examples of FIGS. 1-5 may be implemented.

### DETAILED DESCRIPTION

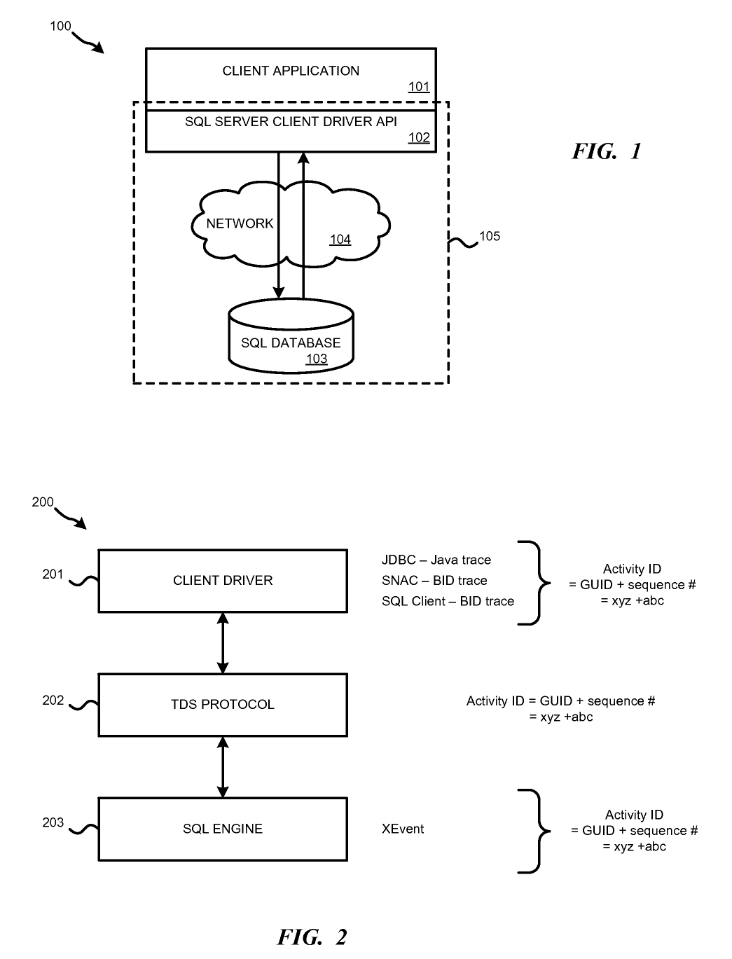

FIG. 1 is a high level block diagram of a client-server database system 100 according to one embodiment. Client application 101 comprises code that is run on a client machine to provide database functionality to users. Client application 101 includes SQL Server® client driver API (Application Programming Interface) client driver 102 that provides a connection to a SQL database 103 through network 104. The user can save data to SQL database 103 or query the database using client application 101 and SQL Server® client driver API 102. Region 105 represents a stack associated with SQL database 103. The area outside region 105 in client application 101 is customer-developed code, for example, while the area inside region 105 includes APIs for communicating with the database.

FIG. 2 illustrates an example stack 200 for client-server database system 100 (e.g. region 105 of FIG. 1). Inside stack 200, for example, there is a client driver layer 201, TDS protocol layer 202, and SQL engine layer 203. Client driver 201 may be, for example, SNAC (SQL Native Client), JDBC (Java Database Connectivity), or a SQL client such as ADO.NET (ActiveX Data Objects for .NET) depending upon the technology selected for the client application. SNAC combines an ODBC driver and OLE DB provider in a single DLL for Microsoft's SQL Server®. JDBC is a Java-based data access technology from Sun Microsystems, Inc. ADO.NET is a set of computer software components that programmers can use to access data and data services using the Microsoft®.NET Framework. TDS protocol 202 is an application-level protocol used for the transfer of requests and responses between client driver 201 and database engine 203 as described above.

In a typical client application, the stack 200 is used by a client application to open a connection to a database server and to execute requests, such as SQL batch or RPC (Remote Procedure Call) requests. The requests may access data in the database or provide data to the database.

The client application will sometimes fail when it attempts to execute the SQL batch or RPC requests. For example, the client application may fail if the network is down due to a bad router or a network hardware problem. Other failures may occur when the application running on the client machine is slow to send the request, the client machine crashes, or the client driver fails. Problems with the SQL engine may also cause failures, such as when the database server is too busy to respond to the request and the request is dropped. In existing systems, there is no way to determine what caused these failures. Instead, users could track a packet through each part of the stack in an attempt to identify how far a packet traveled through the system and thereby determine where a failure occurred. Because thousands of packets are sent thorough the system, it was very difficult to identify and track individual packets. Therefore, it is difficult to trouble shoot the system and to correlate what happened at the client driver to what happened at the SQL engine.

An optional Trace Header may be added to the TDS protocol for the SQL batch, RPC or other requests in a way that does not interfere with the protocol. The Trace Header acts as a “breadcrumb” so that request packets may be tracked through the system. When the Trace Header is present and tracing is active in the stack, the Trace Header is captured and persisted or logged at each layer 201-203. Each layer has different tracing mechanisms as illustrated in FIG. 2. For example, depending upon the technology selected in the client driver 201, JDBC uses Java trace and SNAC and SQL Client use BID (Built-In Diagnostics) tracing. BID trace is the client driver trace. TDS 202 carries the Activity ID, which is exposed in the client-side BID trace. SQL Engine 203 may use Extended Event trace to correlate requests. The Trace Header leaves “breadcrumbs” inside each tracing mechanism so that the user can exactly know where a request packet has been. This allows the user to map the request packet through the system.

Request message streams can be preceded by a variable number of headers. Stream headers are present only in the first packet of requests that may span more than one packet. The Trace Header data stream contains a client trace Activity ID that may be used by the server for debugging purposes and to allow correlation of a client request with the server's processing of the request.

The Activity ID is a randomly generated sixteen-byte GUID plus a four-byte sequence number. The GUID corresponds to a thread on the client machine, and a new sequence number is assigned to each request sent by that thread. The Trace Header is added within the stream of request packets. When the Trace Header is sent and tracing is turned on within client driver 201, for example, the Activity ID will be found within the trace points for the client driver. Similarly, within TDS protocol 202 and SQL Engine 203 tracing, the Activity ID will also be found. As illustrated in FIG. 2, if the randomly generated sixteen-byte GUID is “xyz” and the sequence number is “abc,” then that Activity ID “xyz-abc” will be found in the tracing for each layer of the stack that received the request.

In one embodiment, all request types, including SQL batch and RPC requests, in the client-server database system are tagged with the Activity ID in the Trace Header. This allows tracing to be used to track where the request passed through the system. The Trace Header is an optional header that does not break the connection protocol. If the Trace Header is present, then tracing will log the packet; otherwise, if the packet is missing, the protocol will operate normally.

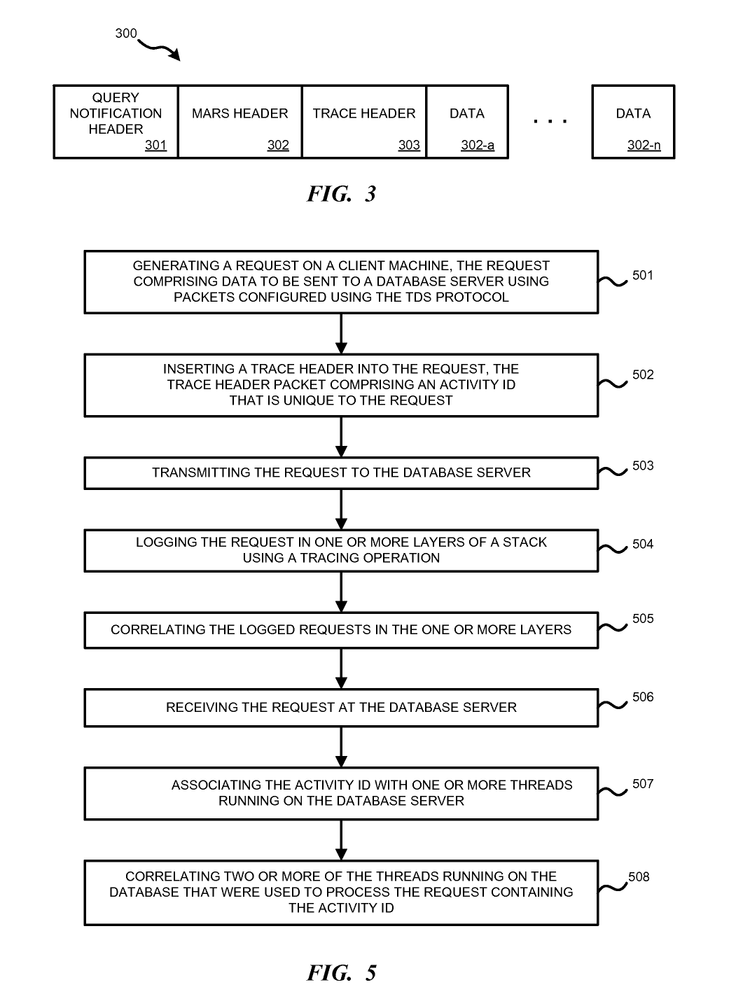

FIG. 3 illustrates a message stream 300 that form a request. The stream 300 includes a group of headers, such as a Query Notifications Header 301 or MARS Header 302, and a group of data packets 302a-n. An optional Trace Header 303 may also be added to the stream 300. Trace Header 303 includes the Activity ID, such as a randomly generated sixteen-byte GUID plus four-byte sequence number. The stream of packets 300 may be associated with any batch, RPC, or other request.

The Activity ID in Trace Header 303 is logged by tracing in each layer of the stack. The request can then be tracked across the system and through the stack by looking for the specific Activity ID assigned to the request. If the Activity ID does not appear in the trace for a particular layer, then the failure point of the request can be identified. For example, if the Activity ID trace point does not appear in TDS, then the user knows that the request packets did not reach the TDS protocol. Similarly, if the Activity ID trace point is not found in the SQL Engine, then the user knows that the network packet from the client did not reach the server. This assists the user in identifying the source of a network problem.

In other embodiments, the Activity ID trace point may be used to identify particular request packets out of thousands of packets in the network, thereby allowing the user to focus on specific requests that have failed or are having problems.

FIG. 4 illustrates how request 401 interacts with various threads within a SQL engine 402. Multiple read threads 403 process incoming requests 401 from client applications. Each incoming request is serviced by a read thread 403, and assigned to one of multiple worker threads 404 to be processed by the SQL engine 402. There may be very many threads running on the SQL engine. For example, there may be tens of read threads 403 and hundreds of worker threads 404 depending upon the size of the system and the number of client applications using the system. Worker threads 404 issue responses 405 to the client applications.

In a database system with many users and an accompanying large number of threads to handle user requests, it has been very difficult—if not impossible—to identify specific requests from a particular client application and to identify the treads processing those specific requests. However, using the Activity ID described herein, these requests can be tracked both through the stack between the client application and the database server and through the threads that particular process the request within the database engine.

This allows users to troubleshoot the entire database system down to the thread level. For example, in a banking application, the database may comprise ATM transaction data. Hundreds or thousands of customers may be using the ATM system at one time and generating hundreds of thousands of transactions a day. If a customer transaction fails, such as not recording a deposit or generating the wrong withdrawal, it would be very difficult to identify the customer transaction and to determine the reason for the failure. In current systems, the requests related to transaction cannot be tracked the through the system. However, by identifying the Activity ID assigned to the requests that are associated with the customer's transaction, the failed requests can be tracked through the system tracing to locate the source of the problem.

An Activity ID correlator may be exposed to users using error messages, connection object APIs, and/or exception object APIs. The Activity ID correlator exactly correlates a thread and request on the client machine with threads on the database server. The Activity ID is logged into an XEvent on the server to correlate a server XEvent to a client BID trace.

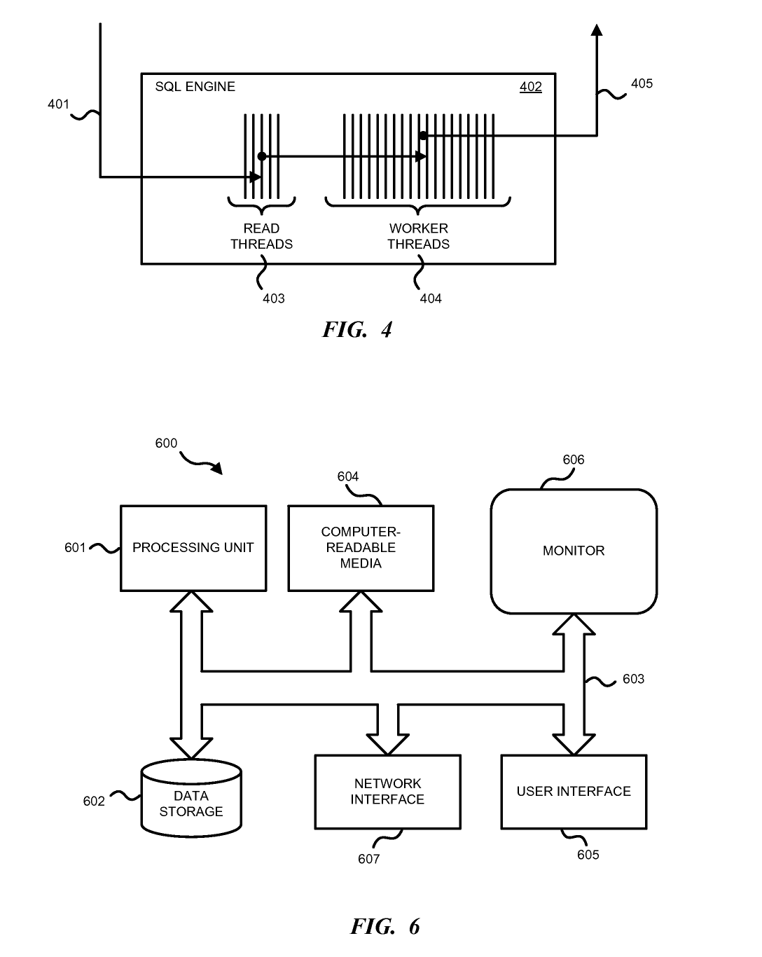

FIG. 5 is a flowchart illustrating a method or process for tracing requests in a database system. In step 501, a request is generated on a client machine. The request comprises data to be sent to a database server using packets configured using the TDS protocol. In step 502, a trace header is inserted into the request. The trace header comprises an Activity ID that is unique to the request. The Activity ID may be a sixteen-byte, randomly generated globally unique identifier plus a four-byte sequence number, for example, or any other unique number or identifier. In step 503, the request is transmitted to the database server.

The request is logged in one or more layers of a stack using a tracing operation in step 504. The logging step may include, for example, logging the request in a client driver stack layer, logging the request in a TDS protocol stack layer, and logging the request in a database server stack layer using a trace operation appropriate for the technology used in each layer. In step 505, the logged requests are correlated.

In step 506, the request is received at the database server. The Activity ID is associated with one or more threads running on the database server in step 507. In step 508, two or more of the threads that were used to process the request containing the Activity ID are correlated. In one embodiment, the request is a batch or RPC request, but any request may be traced using the techniques set forth herein in other embodiments.

It will be understood that steps 501-508 of the process illustrated in FIG. 5 may be executed simultaneously and/or sequentially. It will be further understood that each step may be performed in any order and may be performed once or repetitiously.

FIG. 6 illustrates an example of a suitable computing and networking environment 600 on which the examples of FIGS. 1-5 may be implemented. Computing system 600 may be used as a client machine running a client application and/or as a database server running a SQL engine, for example. Multiple instances of computing system 600, such as one or more client machine instances, may be coupled to other instances of the computing system 600, such as one or more server database instances. The computing system environment 600 is only one example of a suitable computing environment and is not intended to suggest any limitation as to the scope of use or functionality of the invention. The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 600. Components may include, but are not limited to, various hardware components, such as processing unit 601, data storage 602, such as a system memory, and system bus 603 that couples various system components including the data storage 602 to the processing unit 601. The system bus 603 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 600 typically includes a variety of computer-readable media 604. Computer-readable media 604 may be any available media that can be accessed by the computer 600 and includes both volatile and nonvolatile media, and removable and non-removable media, but excludes propagated signals. By way of example, and not limitation, computer-readable media 604 may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 600. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media. Computer-readable media may be embodied as a computer program product, such as software stored on computer storage media.

The data storage or system memory 602 includes computer storage media in the form of volatile and/or nonvolatile memory such as read only memory (ROM) and random access memory (RAM). A basic input/output system (BIOS), containing the basic routines that help to transfer information between elements within computer 600, such as during start-up, is typically stored in ROM. RAM typically contains data and/or program modules that are immediately accessible to and/or presently being operated on by processing unit 601. By way of example, and not limitation, data storage 602 holds an operating system, application programs, and other program modules and program data.

Data storage 602 may also include other removable/non-removable, volatile/nonvolatile computer storage media. By way of example only, data storage 602 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media, described above and illustrated in FIG. 6, provide storage of computer-readable instructions, data structures, program modules and other data for the computer 600.

A user may enter commands and information through a user interface 605 or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other natural user interface (NUI) may also be used with the appropriate input devices, such as a microphone, camera, tablet, touch pad, glove, or other sensor. These and other input devices are often connected to the processing unit 601 through a user input interface 605 that is coupled to the system bus 603, but may be connected by other interface and bus structures, such as a parallel port, game port or a universal serial bus (USB). A monitor 606 or other type of display device is also connected to the system bus 603 via an interface, such as a video interface. The monitor 606 may also be integrated with a touch-screen panel or the like. Note that the monitor and/or touch screen panel can be physically coupled to a housing in which the computing device 600 is incorporated, such as in a tablet-type personal computer. In addition, computers such as the computing device 600 may also include other peripheral output devices such as speakers and printer, which may be connected through an output peripheral interface or the like.

The computer 600 may operate in a networked or cloud-computing environment using logical connections 607 to one or more remote devices, such as a remote computer. The remote computer may be a personal computer, a server, a router, a network PC, a peer device or other common network node, and typically includes many or all of the elements described above relative to the computer 600. The logical connections depicted in FIG. 6 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 600 may be connected to a public or private network through a network interface or adapter 607. In some embodiments, a modem or other means for establishing communications over the network. The modem, which may be internal or external, may be connected to the system bus 603 via the network interface 607 or other appropriate mechanism. A wireless networking component such as comprising an interface and antenna may be coupled through a suitable device such as an access point or peer computer to a network. In a networked environment, program modules depicted relative to the computer 600, or portions thereof, may be stored in the remote memory storage device. It may be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
generating a request by a thread on a client machine, the request comprising data to be sent to a database server using packets configured using a Tabular Data Stream (TDS) protocol;
inserting a trace header into the request, the trace header comprising an activity identifier that is unique to the request, the activity identifier comprising a randomly generated globally unique identifier (GUID) associated with the thread on the client machine plus a sequence number associated with the request generated by the thread, wherein a new sequence number is assigned to each request sent by the thread; and
transmitting the request to the database server.

2. The computer-implemented method of claim 1, further comprising:
logging the request in one or more layers of a stack using a tracing operation.

3. The computer-implemented method of claim 1, further comprising:
logging the request in a client driver stack layer;
logging the request in a TDS protocol stack layer; and
logging the request in a database server stack layer.

4. The computer-implemented method of claim 3, further comprising:
correlating the logged requests in the client driver stack layer, the TDS protocol stack layer, and the database server stack layer using the activity identifier.

5. The computer-implemented method of claim 1, further comprising:
receiving the request at the database server; and
associating the activity identifier with one or more threads running on the database server.

6. The computer-implemented method of claim 5, further comprising:
correlating two or more of the threads running on the database that were used to process the request containing the activity identifier.

7. The computer-implemented method of claim 1, wherein the request is a SQL batch or Remote Procedure Call (RPC) request.

8. The computer-implemented method of claim 1, wherein the GUID a sixteen-byte number and the sequence number is a four-byte number.

9. The computer-implemented method of claim 1, further comprising:
generating a response on database server, the response comprising data to be sent to the client machine using packets configured using the TDS protocol;
inserting a trace header into the response, the trace header comprising the activity identifier; and
transmitting the response to the client machine.

10. A computer system, comprising:
one or more processors;
system memory;
one or more computer-readable storage media having stored thereon computer-executable instructions that, when executed by the one or more processors, causes the processors to perform a method for tracing requests in a database system, the processor operating to:
generate a request by a thread, the request comprising data to be sent to a database server using packets configured using a Tabular Data Stream (TDS) protocol;
insert a trace header into the request, the trace header comprising a activity identifier that is unique to the request, the activity identifier comprising a randomly generated globally unique identifier (GUID) associated with the thread on the client machine plus a sequence number associated with the request generated by the thread, wherein a new sequence number is assigned to each request sent by the thread; and
transmit the request to the database server.

11. The computer system of claim 10, the processor further operating to:
log the request in one or more layers of a stack using a tracing operation.

12. The computer system of claim 10, the processor further operating to:
log the request in a client driver stack layer;
log the request in a TDS protocol stack layer; and
log the request in a database server stack layer.

13. The computer system of claim 10, the processor further operating to:
correlate the logged requests in the client driver stack layer, the TDS protocol stack layer, and the database server stack layer using the activity identifier.

14. The computer system of claim 10, wherein the request is a SQL batch or Remote Procedure Call (RPC) request.

15. The computer system of claim 10, wherein the GUID a sixteen-byte number and the sequence number is a four-byte number.

16. A computer-implemented method, comprising:
receiving a request by a thread on a database server, the request comprising data packets configured using a Tabular Data Stream (TDS) protocol;
identifying a trace header in the request, the trace header comprising an activity identifier that is unique to the request, the activity identifier comprising a randomly generated globally unique identifier (GUID) associated with the thread on the client machine plus a sequence number associated with the request generated by the thread, wherein a new sequence number is assigned to each request sent by the thread; and
associating the activity identifier with one or more threads running on the database server.

17. The computer-implemented method of claim 16, further comprising:
correlating two or more of the threads running on the database that were used to process the request containing the activity identifier.

18. The computer-implemented method of claim 16, further comprising:
generating a response on database server, the response comprising data to be sent to a client machine using packets configured using the TDS protocol;
inserting a trace header into the response, the trace header comprising the activity identifier; and
transmitting the response to the client machine.

19. The computer-implemented method of claim 16, wherein the request is a SQL batch or Remote Procedure Call (RPC) request.

20. The computer-implemented method of claim 16, wherein the GUID a sixteen-byte number and the sequence number is a four-byte number.
